(19) United States
(12) Patent Application Publication
(10) Pub. No.: US 2022/0308477 A1
(43) Pub. Date: Sep. 29, 2022

(54) METHOD FOR PRODUCING TONER FOR DEVELOPING ELECTROSTATIC CHARGE IMAGE, AND TONER FOR DEVELOPING ELECTROSTATIC CHARGE IMAGE

(71) Applicant: FUJIFILM Business Innovation Corp., Tokyo (JP)

(72) Inventors: Takahisa TATEKAWA, Kanagawa (JP); Atsushi SUGAWARA, Kanagawa (JP); Hiroshi NAKAZAWA, Kanagawa (JP)

(73) Assignee: FUJIFILM Business Innovation Corp., Tokyo (JP)

(21) Appl. No.: 17/468,019

(22) Filed: Sep. 7, 2021

(30) Foreign Application Priority Data
Mar. 23, 2021 (JP) 2021-049121

(51) Int. Cl. G03G 9/08; G03G 9/087

(52) U.S. Cl. CPC G03G 9/081; G03G 9/0812; G03G 9/08755

(57) ABSTRACT

A method for producing a toner for developing an electrostatic charge image includes aggregating at least resin particles contained in a dispersion to form aggregated particles; and heating and fusing the aggregated particles to form fused particles, in which, in the aggregating, aggregation is performed by taking out a portion of the dispersion containing the resin particles mixed in a stirring vessel, adding an aggregating agent aqueous solution thereto, passing the resulting mixture through a dispersing machine, and then returning the resulting mixture to the stirring vessel so as to circulate the dispersion, and when adding the aggregating agent aqueous solution, an aqueous solution containing an aggregating agent at a concentration of 0.1 mass % or more and 5 mass % or less is added at a flow rate q (L/min) such that a ratio of this flow rate q (L/min) to a flow rate Q (L/min) of the mixture returning from the dispersing machine to the stirring vessel is 0.01 or more and 0.1 or less.

### CROSS-REFERENCE TO RELATED APPLICATIONS

This application is based on and claims priority under 35 USC 119 from Japanese Patent Application No. 2021-049121 filed Mar. 23, 2021.

### BACKGROUND

### (i) Technical Field

The present disclosure relates to a method for producing a toner for developing an electrostatic charge image, and a toner for developing an electrostatic charge image.

### (ii) Related Art

Image information visualizing methods, such as electrophotography, are presently used in various fields. In electrophotography, an electrostatic charge image is formed as image information on a surface of an image carrying body by charging and forming an electrostatic charge image. Then a toner image is formed on the surface of the image carrying body by using a developer that contains a toner, and, after the toner image is transferred onto a recording medium, the toner image is fixed onto the recording medium. Through these steps, image information is visualized into an image.

For example, Japanese Unexamined Patent Application Publication No. 2002-323796 discloses a method for producing a toner for developing an electrostatic charge image, the method including mixing a resin fine particle dispersion, a coloring agent dispersion, and a polymer aggregating agent aqueous solution, forming aggregated particles that contain resin fine particles and coloring agent particles, and heating and fusing the aggregated particles, in which a mechanical shear force is applied to the polymer aggregating agent aqueous solution to disintegrate the polymer aggregating agent, and then the disintegrated polymer aggregating agent is added in the mixing step.

Japanese Unexamined Patent Application Publication No. 2005-140987 discloses a method for producing an electrophotographic toner that contains at least a coloring agent and a binder resin containing a crystalline resin, the method including: an aggregation step of mixing a coloring agent particle dispersion containing dispersed particles of the coloring agent and a resin particle dispersion containing at least dispersed particles of a carboxylic acid group-containing crystalline resin and having a pH of 6.0 or more and 10.0 or less and a zeta potential of −60 mV or more and −30 mV or less and performing aggregation so as to obtain an aggregated particle dispersion containing dispersed aggregated particles containing particles of the crystalline resin and particles of the coloring agent; and a fusing step of heating the aggregated particle dispersion to fuse the aggregated particles and obtain toner particles.

### SUMMARY

Aspects of non-limiting embodiments of the present disclosure relate to a method for producing a toner for developing an electrostatic charge image, with which the property of suppressing the image density nonuniformity in the obtained image is excellent compared to a method that includes aggregating at least resin particles contained in a dispersion to form aggregated particles; and heating and fusing the aggregated particles to form fused particles, in which, in the aggregating, aggregation is performed by taking out a portion of the dispersion containing the resin particles mixed in a stirring vessel, adding an aggregating agent aqueous solution thereto, passing the resulting mixture through a dispersing machine, and then returning the resulting mixture to the stirring vessel so as to circulate the dispersion, and, when adding the aggregating agent aqueous solution, an aqueous solution containing an aggregating agent at a concentration of less than 0.1 mass % or more than 5 mass % is added at a flow rate q (L/min) such that a ratio of this flow rate q (L/min) to a flow rate Q (L/min) of the mixture returning from the dispersing machine to the stirring vessel is less than 0.01 or more than 0.1.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a method for producing a toner for developing an electrostatic charge image, the method including aggregating at least resin particles contained in a dispersion to form aggregated particles; and heating and fusing the aggregated particles to form fused particles, in which, in the aggregating, aggregation is performed by taking out a portion of the dispersion containing the resin particles mixed in a stirring vessel, adding an aggregating agent aqueous solution thereto, passing the resulting mixture through a dispersing machine, and then returning the resulting mixture to the stirring vessel so as to circulate the dispersion, and when adding the aggregating agent aqueous solution, an aqueous solution containing an aggregating agent at a concentration of 0.1 mass % or more and 5 mass % or less is added at a flow rate q (L/min) such that a ratio of this flow rate q (L/min) to a flow rate Q (L/min) of the mixture returning from the dispersing machine to the stirring vessel is 0.01 or more and 0.1 or less.

### BRIEF DESCRIPTION OF THE DRAWINGS

Exemplary embodiments of the present disclosure will be described in detail based on the following figures, wherein:

FIG. 1 is a schematic diagram illustrating one example of an image forming apparatus according to an exemplary embodiment; and

FIG. 2 is a schematic diagram illustrating one example of a process cartridge according to an exemplary embodiment.

### DETAILED DESCRIPTION

Hereinafter, exemplary embodiments, which are some examples of the present disclosure, are described in detail.

When numerical ranges are described stepwise, the upper limit or the lower limit of one numerical range may be substituted with an upper limit or a lower limit of a different numerical range also described stepwise.

In any numerical range, the upper limit or the lower limit of the numerical range may be substituted with a value indicated in Examples.

When multiple substances that correspond to a particular component in a composition are present in the composition, the amount of that component in the composition is the total amount of the multiple substances present in the composition unless otherwise noted.

The term “step” refers not only to an independent step but also to any feature that attains the intended purpose of the step even if this feature is not clearly distinguishable from other steps.

### Method for Producing Toner for Developing Electrostatic Charge Image

A method for producing a toner for developing an electrostatic charge image according to an exemplary embodiment includes an aggregation step of aggregating at least resin particles contained in a dispersion to form aggregated particles; and a fusing step of heating and fusing the aggregated particles to form fused particles. In the aggregation step, aggregation is performed by taking out a portion of the dispersion containing the resin particles mixed in a stirring vessel, adding an aggregating agent aqueous solution thereto, passing the resulting mixture through a dispersing machine, and then returning the resulting mixture to the stirring vessel so as to circulate the dispersion. When adding the aggregating agent aqueous solution, an aqueous solution containing an aggregating agent at a concentration of 0.1 mass % or more and 5 mass % or less is added at a flow rate q (L/min) such that a ratio of this flow rate q (L/min) to a flow rate Q (L/min) of the mixture returning from the dispersing machine to the stirring vessel is 0.01 or more and 0.1 or less.

A toner for developing an electrostatic charge image according to an exemplary embodiment is a toner produced by the method for producing the toner for developing an electrostatic charge image of the aforementioned exemplary embodiment.

One of the toner particle production methods is a wet process method. An example of the wet process method disclosed heretofore is a method for producing a core-shell toner, the method involving aggregating binder resin particles, releasing agent particles, etc., by using an aggregating agent such as a metal salt, causing a shell to adhere onto surfaces of aggregated particles to form core-shell particles, terminating aggregation growth by using an alkaline aqueous solution or the like, and heating and fusing the resulting aggregated particles.

The wet process method can more precisely control the toner structure compared to a disintegration method and can narrow the toner particle size distribution and shape distribution. However, when an aggregating agent is mixed with a raw material dispersion, the aggregating agent is not rapidly and evenly dispersed, and there have been cases where the toner formed as a result contains the unevenly distributed aggregating agent, and the image density nonuniformity occurs due to melting unevenness.

In the method for producing a toner for developing an electrostatic charge image according to this exemplary embodiment, in the aggregation step, one portion of a dispersion containing the resin particles mixed in a stirring vessel is taken out, an aggregating agent aqueous solution is added thereto, and the resulting mixture is passed through a dispersing machine and then returned to the stirring vessel so as to conduct aggregation while causing the dispersion to circulate. Moreover, when adding the aggregating agent aqueous solution, an aqueous solution containing an aggregating agent at a concentration of 0.1 mass % or more and 5 mass % or less is added at a flow rate q (L/min) such that the ratio of this flow rate q (L/min) to a flow rate Q (L/min) of the mixture returning from the dispersing machine to the stirring vessel is 0.01 or more and 0.1 or less. In this manner, during addition of the aggregating agent, the aggregating agent is substantially evenly mixed with the entire dispersion, and thus this operation can be performed at a low density and a low pH (when addition is performed at a high pH, the aggregating agent is neutralized, and the aggregation force is degraded). Moreover, since the aggregating agent is added while performing dispersing, the aggregating agent concentration becomes more uniform, and presumably thus the difference in density of the image produced by using the obtained toner can be reduced.

The method for producing a toner for developing an electrostatic charge image according to this exemplary embodiment involves forming toner particles by an aggregation and coalescence method.

Hereinafter, steps other than those described above are described in detail.

### Aggregation Step

The method for producing a toner for developing an electrostatic charge image according to this exemplary embodiment includes an aggregation step of aggregating at least resin particles contained in a dispersion to form aggregated particles. In this aggregation step, one portion of the dispersion containing the resin particles mixed in a stirring vessel is taken out, an aggregating agent aqueous solution is added thereto, and the resulting mixture is passed through a dispersing machine and then returned to the stirring vessel so as to conduct aggregation while causing the dispersion to circulate. In adding the aggregating agent aqueous solution, an aqueous solution containing an aggregating agent at a concentration of 0.1 mass % or more and 5 mass % or less is added at a flow rate q (L/min) such that the ratio of this flow rate q (L/min) to a flow rate Q (L/min) of the mixture returning from the dispersing machine to the stirring vessel is 0.01 or more and 0.1 or less.

The dispersion used in this aggregation step contains at least the resin particles, and may contain at least resin particles and releasing agent particles. If needed, the dispersion may further contain coloring agent particles and the like.

The method for preparing the dispersion is not particularly limited. The dispersion can be prepared by mixing a resin particle dispersion and a releasing agent particle dispersion, or can be prepared by mixing the resin particle dispersion, the releasing agent particle dispersion, and a coloring particle dispersion.

In the dispersion, at least the resin particles are aggregated to prepare a dispersion containing aggregated particles.

Specifically, the aforementioned aggregation involves adjusting the pH of the dispersion to acidic (for example, a pH of 2 or more and 5 or less), taking out a portion of the dispersion containing the resin particles mixed in the stirring vessel, adding an aggregating agent aqueous solution thereto, passing the resulting mixture through a dispersing machine and then returning the resulting mixture to the stirring vessel to circulate the dispersion, adding a dispersion stabilizer as needed, and heating the resulting mixture to a temperature corresponding to the glass transition temperature of the resin particles (specifically, for example, a temperature 30° C. to 10° C. lower than the glass transition temperature of the resin particles) to aggregate the particles dispersed in the dispersion and to thereby form aggregated particles.

In the aggregation step, for example, the heating may be performed after a portion of the dispersion containing the resin particles mixed in the stirring vessel is taken out at room temperature (for example, 25° C.) while stirring the dispersion in the stirring vessel, the aggregating agent aqueous solution is added thereto, the resulting mixture is passed through a dispersing machine and then returned to the stirring vessel to circulate the dispersion, the pH of the dispersion adjusted to acidic (for example, a pH of 2 or more and 5 or less), and a dispersion stabilizer is added as necessary.

Examples of the inorganic metal salt include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

Among these, from the viewpoint of the property of suppressing image density nonuniformity, preferably a trivalent or higher metal ion salt compound and more preferably a trivalent aluminum salt compound is contained as the aggregating agent.

From the viewpoint of the property of suppressing image density nonuniformity, the total amount of the aggregating agent added in the aggregation step relative to the total mass of the toner particles to be obtained is preferably 0.05 mass % or more and 5.0 mass % or less, more preferably 0.1 mass % or more and 2.0 mass % or less, and yet more preferably 0.5 mass % or more and 1.5 mass % or less.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), ethylenediaminetetraacetic acid (EDTA), and salts thereof.

The amount of the chelating agent added is, for example, preferably 0.01 parts by mass or more and 5.0 parts by mass or less and more preferably 0.1 parts by mass or more and less than 3.0 parts by mass relative to 100 parts by mass of the resin particles.

The dispersion used in the aggregation step is preferably a water-based dispersion and is more preferably a water dispersion.

Examples of the dispersion medium used in the dispersion in the aggregation step include water-based media.

Examples of the water-based media include water such as distilled water and ion exchange water, and alcohols. These may be used alone or in combination.

In the aggregation step, a stirring vessel equipped with a circulation section that has an aggregating agent aqueous solution adding unit can be used.

From the viewpoints of the dispersibility of the aggregating agent and the property of suppressing image density nonuniformity, the circulation section can have a liquid feed port, through which the dispersion is returned to the stirring vessel, and this liquid feed port can be connected to the stirring vessel at a position on the lower side in the direction of gravitational force with respect to the liquid level of the dispersion in the stirring vessel.

That is, from the viewpoints of the dispersibility of the aggregating agent and the property of suppressing image density nonuniformity, in the aggregation step of the method for producing a toner for developing an electrostatic charge image of the exemplary embodiment, the dispersion can be returned to the stirring vessel at a position on the lower side in the direction of gravitational force with respect to the liquid level of the dispersion in the stirring vessel.

In addition, from the viewpoints of the dispersibility of the aggregating agent and the property of suppressing image density nonuniformity, in the aggregation step of the method for producing a toner for developing an electrostatic charge image of this exemplary embodiment, the dispersion can be taken out from the stirring vessel at a position on the lower side in the direction of gravitational force with respect to the liquid level of the dispersion in the stirring vessel.

From the viewpoints of the dispersibility of the aggregating agent and the property of suppressing image density nonuniformity, a discharge port through which the dispersion is taken out from the stirring vessel can be connected the stirring vessel at a position on the lower side in the direction of gravitational force with respect to the liquid feed port through which the dispersion is returned to the stirring vessel.

The pipe length from the aggregating agent adding position (the position where the aggregating agent aqueous solution is added to the dispersion containing resin particles) to the inlet port of the dispersing machine is preferably 100D or less and more preferably 50D or less where D represents the inner diameter of the pipe connected to the dispersing machine.

From the viewpoints of the dispersibility of the aggregating agent and the property of suppressing the image density nonuniformity, the dispersing machine may have a dispersing unit that applies mechanical shear force to the dispersion.

The dispersing machine is not particularly limited, and an example thereof is a cavitron dispersing machine.

Furthermore, in the method for producing a toner for developing an electrostatic charge image of the exemplary embodiment, a portion of the dispersion containing the resin particles mixed in the stirring vessel in the aggregation step can be taken out continuously from the viewpoints of the dispersibility of the aggregating agent and the property of suppressing the image density nonuniformity.

In the method for producing a toner for developing an electrostatic charge image of this exemplary embodiment, the aggregating agent aqueous solution to be added is an aqueous solution containing an aggregating agent at a concentration of 0.1 mass % or more and 5 mass % or less. From the viewpoints of the dispersibility of the aggregating agent and the property of suppressing image density nonuniformity, the concentration of the aggregating agent aqueous solution is preferably 0.5 mass % or more and 4.5 mass % or less, more preferably 0.8 mass % or more and 4.0 mass % or less, and yet more preferably 1.0 mass % or more and 2.0 mass % or less.

When the aggregating agent aqueous solution is added in the method for producing a toner for developing an electrostatic charge image according to this exemplary embodiment, an aqueous solution containing an aggregating agent having a concentration of 0.1 mass % or more and 5 mass % or less is added at a flow rate q (L/min) such that the ratio of this flow rate q (L/min) to a flow rate Q (L/min) of the mixture returning from the dispersing machine to the stirring vessel is 0.01 or more and 0.1 or less.

The value of q/Q is preferably 0.02 or more and 0.09 or less, more preferably 0.04 or more and 0.08 or less yet more preferably 0.05 or more and 0.07 or less from the viewpoints of the dispersibility of the aggregating agent and the property of suppressing image density nonuniformity.

The zeta potential of at least one dispersion selected from the resin particle dispersion, the releasing agent particle dispersion, and the coloring particle dispersion used in preparing the dispersion in the aggregation step is preferably −40 mV or less, more preferably −50 mV or less, and particularly preferably −100 mV or more and −60 mV or less from the viewpoint of the property of suppressing image density nonuniformity.

The difference between the maximum value and the minimum value among the zeta potentials of the resin particle dispersion, the releasing agent particle dispersion, and the coloring particle dispersion used in preparing the dispersion in the aggregation step is preferably 50 mV or less, more preferably 40 mV or less, and particularly preferably 0 mV or more and 35 mV or less from the viewpoint of the property of suppressing image density nonuniformity.

Furthermore, among the zeta potential of the resin particle dispersion, the zeta potential of the releasing agent particle dispersion, and the zeta potential of the coloring particle dispersion, the zeta potential of the releasing agent particle dispersion can be the lowest from the viewpoint of the property of suppressing image density nonuniformity.

The zeta potential of the resin particle dispersion is preferably −70 mV or more and −20 mV or less, more preferably −60 mV or more and −25 mV or less, and yet more preferably −50 mV or more and −30 mV or less from the viewpoint of the property of suppressing image density nonuniformity.

The zeta potential of the releasing agent particle dispersion is preferably −100 mV or more and −20 mV or less, more preferably −90 mV or more and −30 mV or less, and yet more preferably −80 mV or more and −50 mV or less from the viewpoint of the property of suppressing image density nonuniformity.

The zeta potential of the coloring agent particle dispersion is preferably −70 mV or more and −20 mV or less, more preferably −60 mV or more and −25 mV or less, and yet more preferably −50 mV or more and −30 mV or less from the viewpoint of the property of suppressing image density nonuniformity.

The zeta potentials of the dispersions in this exemplary embodiment are measured by using a microscope laser zeta potentiometer ZC-300 (produced by Microtec Co., Ltd.). Specifically, a dispersion is placed in a 10 mm transparent cell, and the moving speed of particles in the dispersion in the cell is observed with a microscope simultaneously with application of 300 V voltage at an inter-electrode distance of 9 mm to calculate the moving speed. The zeta potential is then determined from the moving speed.

The dispersion used in the aggregation step can contain a surfactant.

Examples of the surfactant include anionic surfactants such as sulfate surfactants, sulfonate surfactants, phosphate surfactants, and soap surfactants; cationic surfactants such as amine salt surfactants and quaternary ammonium salt surfactants; and nonionic surfactants such as polyethylene glycol surfactants, alkyl phenol ethylene oxide adduct surfactants, and polyhydric alcohol surfactants. Among these, an anionic surfactant and a cationic surfactant are preferable. A nonionic surfactant may be used in combination with an anionic surfactant or a cationic surfactant.

These surfactants may be used alone or in combination.

The volume average particle diameter of the resin particles before aggregation dispersed in the dispersion is preferably 0.01 μm or more and 1 μm or less, more preferably 0.08 μm or more and 0.8 μm or less, and yet more preferably 0.1 μm or more and 0.6 μm or less.

The volume average particle diameter of the releasing agent particles before aggregation dispersed in the dispersion is preferably 0.01 μm or more and 1 μm or less, more preferably 0.08 μm or more and 0.8 μm or less, and yet more preferably 0.1 μm or more and 0.6 μm or less.

The volume average particle diameters of the resin particles and the releasing agent particles are each determined by using a particle size distribution obtained by measurement with a laser diffraction particle size distribution meter (for example, LA-700 produced by Horiba Ltd.), drawing a cumulative distribution with respect to volume from the small diameter size relative to the divided particle size ranges (channels), and assuming the particle diameter at 50% accumulation relative to all particles as D50v. The volume average particle diameters of other particles in the dispersion are also measured in a similar manner.

The resin particles used in the aggregation step preferably contain polyester resin particles and more preferably are polyester resin particles from the viewpoints of the property of suppressing the occurrence of color spots in the obtained image and the property of suppressing fogging.

The resin particles in the aggregation step preferably contain amorphous resin particles and more preferably contain amorphous resin particles and crystalline resin particles.

As described above, the dispersion may further contain coloring agent particles used in the toner particles, and the like.

The volume average particle diameter of the coloring agent particles may be the same as that of the resin particles.

The time for which the circulation is performed in the aggregation step is not particularly limited; however, from the viewpoint of the dispersibility of the aggregating agent and the property of suppressing image density nonuniformity, the time is preferably 1 minute or more and 120 minutes or less, more preferably 2 minutes or more and 60 minutes or less, and particularly preferably 5 minutes or more and 30 minutes or less.

In the aggregation step, from the viewpoint of the dispersibility of the resin particles, the releasing agent particles, etc., the solid component concentration of the dispersion is preferably 5 mass % or more and 30 mass % or less, more preferably 8 mass % or more and 25 mass % or less, and yet more preferably 11 mass % or more and 20 mass % or less.

The volume average particle diameter of the aggregated particles obtained in the aforementioned aggregation step is not particularly limited, and can be appropriately selected according to the intended volume average particle diameter of the toner particles.

The aggregation may be terminated by any known method, such as increasing the pH. An example of the method for increasing the pH is addition of a basic compound. Examples of the basic compound are those described below in the pH adjusting step.

The individual components, such as a binder resin, a releasing agent, and a coloring agent, contained in the toner particles are described below.

### Fusing Step

The method for producing a toner for developing an electrostatic charge image according to this exemplary embodiment includes a fusing step of heating and fusing the aggregated particles to form fused particles.

In the fusing step, a dispersion containing the dispersed aggregated particles is heated to a temperature equal to or higher than the glass transition temperatures of the resin particles (for example, a temperature 30° C. to 50° C. higher than the glass transition temperature of the resin particles) so as to fuse and coalesce the aggregated particles to thereby form fused particles.

When the releasing agent particles are aggregated in the aggregation step described above, the resin and the releasing agent are in a compatibilized state in the fusing step at a temperature equal to or higher than the glass transition temperature of the resin particles and equal to or higher than the melting temperature of the releasing agent. Subsequently, the resulting product is cooled to obtain toner particles.

Here, upon completion of the fusing step, the toner particles formed in the solution are subjected to a known washing step, a known solid-liquid separation step, and a known drying step to obtain dry toner particles.

The washing step may involve thorough substitution washing with ion exchange water from the standpoint of chargeability. The solid-liquid separation step is not particularly limited but can involve suction filtration, pressure filtration, or the like from the viewpoint of productivity. Although the drying step is also not particularly limited, from the viewpoint of productivity, freeze drying, air drying, flow drying, vibration flow drying, or the like can be employed.

The method for producing a toner for developing an electrostatic charge image according to this exemplary embodiment can include a step of externally adding an external additive to the obtained toner particles.

The external addition method may use a V blender, a HENSCHEL mixer, a Lodige mixer, or the like, for example. Furthermore, if necessary, coarse particles in the toner may be removed by using a vibrating sieving machine, an air sieving machine, or the like.

### Resin Particle Dispersion Preparation Step

The method for producing a toner for developing an electrostatic charge image according to this exemplary embodiment can include a resin particle dispersion preparation step of preparing a resin particle dispersion.

The method for producing a toner for developing an electrostatic charge image according to this exemplary embodiment can include a step of preparing a coloring agent particle dispersion containing dispersed coloring agent particles and a step of preparing a releasing agent particle dispersion containing dispersed releasing agent particles in addition to the step of preparing the resin particle dispersion containing dispersed resin particles.

A resin particle dispersion is prepared by, for example, dispersing resin particles in a dispersion medium by using a surfactant.

Examples of the dispersion medium used in the resin particle dispersion include water-based media.

Examples of the water-based media include water such as distilled water and ion exchange water, and alcohols. These may be used alone or in combination.

Examples of the surfactant include anionic surfactants such as sulfate surfactants, sulfonate surfactants, phosphate surfactants, and soap surfactants; cationic surfactants such as amine salt surfactants and quaternary ammonium salt surfactants; and nonionic surfactants such as polyethylene glycol surfactants, alkyl phenol ethylene oxide adduct surfactants, and polyhydric alcohol surfactants. Among these, an anionic surfactant and a cationic surfactant are preferable. A nonionic surfactant may be used in combination with an anionic surfactant or a cationic surfactant.

These surfactants may be used alone or in combination.

Examples of the method for dispersing resin particles in a dispersion medium in preparing the resin particle dispersion include typical dispersing methods that use a rotary shear homogenizer, a ball mill having media, a sand mill, a dyno mill, etc. Depending on the type of the resin particles, the resin particles may be dispersed in a dispersion medium by a phase inversion emulsification method. The phase inversion emulsification method is a method that involves dissolving a resin to be dispersed in a hydrophobic organic solvent that can dissolve the resin, adding a base to the organic continuous phase (O phase) to neutralize, and adding a water-based medium (W phase) to the resulting product to perform W/O-to-O/W phase inversion and disperse particles of the resin in the water-based medium.

The volume average particle diameter of the resin particles to be dispersed in the resin particle dispersion is preferably 0.01 μm or more and 1 μm or less, more preferably 0.08 μm or more and 0.8 μm or less, and yet more preferably 0.1 μm or more and 0.6 μm or less.

The amount of the resin particles contained in the resin particle dispersion is preferably 5 mass % or more and 50 mass % or less and more preferably 10 mass % or more and 40 mass % or less.

The coloring agent particle dispersion and the releasing agent particle dispersion can also be prepared in the same manner as the resin particle dispersion. In other words, the volume average particle diameter, the dispersion medium, the dispersing method, and the amount of particles of the particles in the resin particle dispersion equally apply to the coloring agent particles to be dispersed in the coloring agent dispersion and the releasing agent particles to be dispersed in the releasing agent dispersion.

The method for producing a toner for developing an electrostatic charge image of the exemplary embodiment may further include a step of forming second aggregated particles after the aggregation step and before the fusing step. The step of forming second aggregated particles involves further mixing the dispersion containing the aggregated particles and a resin particle dispersion in which binder resin particles are dispersed so that the binder resin particles are further attached to the surfaces of the aggregated particles. Toner particles having a core-shell structure are formed through the step of forming second aggregated particles.

The method for producing a toner for developing an electrostatic charge image according to this exemplary embodiment can further include any known steps other than those described above.

Hereinafter, the respective components in the toner for developing an electrostatic charge image are described in detail.

The toner particles contain a binder resin, a releasing agent, and, if necessary, other components, but can contain a binder resin, a releasing agent, and a coloring agent.

### Binder Resin

The binder resin preferably contains an amorphous resin and more preferably contains an amorphous resin and a crystalline resin from the viewpoints of the image strength and suppression of density nonuniformity in the obtained image. In other words, in the first aggregation step, amorphous resin particles and crystalline resin particles can be contained as the resin particles.

Here, an amorphous resin refers to a resin that exhibits only a stepwise endothermic change rather than a clear endothermic peak in thermal analysis by differential scanning calorimetry (DSC), that is solid at room temperature, and that turns thermoplastic at a temperature equal to or higher than the glass transition temperature.

In contrast, a crystalline resin refers to a resin that has a clear endothermic peak rather than a stepwise endothermic change in differential scanning calorimetry (DSC).

Specifically, for example, a crystalline resin refers to a resin that has an endothermic peak having a half width of 10° C. or less when measured at a heating rate of 10° C./min, and an amorphous resin refers to a resin that has a half width exceeding 10° C. or has no clear endothermic peak.

The amorphous resin will now be described.

Examples of the amorphous resin include known amorphous resins such as amorphous polyester resins, amorphous vinyl resins (for example, styrene acrylic resin), epoxy resins, polycarbonate resins, and polyurethane resins. Among these, amorphous polyester resins and amorphous vinyl resins (in particular, styrene acrylic resins) are preferable and amorphous polyester resins are more preferable from the viewpoints of suppressing density nonuniformity and voids in the obtained image.

An amorphous polyester resin and a styrene acrylic resin can be used in combination as the amorphous resin.

Examples of the amorphous polyester resins include polycondensation products between polycarboxylic acids and polyhydric alcohols. A commercially available amorphous polyester resin or a synthesized amorphous polyester resin may be used as the amorphous polyester resin.

Examples of the polycarboxylic acids include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, and lower (for example, 1 to 5 carbon atoms) alkyl esters thereof. Among these, aromatic dicarboxylic acids can be used as polycarboxylic acids.

A dicarboxylic acid and a tri- or higher carboxylic acid having a crosslinked structure or a branched structure may be used in combination as the polycarboxylic acid. Examples of the tri- or higher carboxylic acid include trimellitic acid, pyromellitic acid, anhydrides thereof, and lower (for example, 1 to 5 carbon atoms) alkyl esters thereof.

These polycarboxylic acids may be used alone or in combination.

Examples of the polyhydric alcohols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferred, and aromatic diols are more preferred as the polyhydric alcohols.

A trihydric or higher alcohol having a crosslinked structure or a branched structure may be used in combination with a diol as the polyhydric alcohol. Examples of the trihydric or higher alcohol include glycerin, trimethylolpropane, and pentaerythritol.

These polyhydric alcohols may be used alone or in combination.

The amorphous polyester resin is obtained by a known production method. Specifically, the amorphous polyester resin is obtained by a method that involves, for example, setting the polymerization temperature to 180° C. or higher and 230° C. or lower, depressurizing the inside of the reaction system as necessary, and performing reaction while removing water and alcohol generated during the condensation. When the monomers of the raw materials do not dissolve or mix at the reaction temperature, a high-boiling-point solvent may be added as a dissolving aid. In such a case, the polycondensation reaction is performed while distilling away the dissolving aid. In the copolymerization reaction, when a poorly compatible monomer is present, that monomer may be subjected to condensation with an acid or alcohol for the condensation in advance, and then subjected to polycondensation with other component.

An example of the binder resin, in particular, the amorphous resin, is a styrene acrylic resin.

A styrene acrylic resin is a copolymer obtained by copolymerizing at least a styrene monomer (a monomer having a styrene skeleton) and a (meth)acryl monomer (a monomer having a (meth)acryl group, preferably, a monomer having a (meth)acryloxy group). The styrene acrylic resin includes, for example, a copolymer of a styrene monomer and a (meth)acrylate monomer.

The acrylic resin moiety in the styrene acrylic resin is a partial structure obtained by polymerizing one or both of an acryl monomer and a methacrylic monomer. The term “(meth)acryl” includes both acryl and methacryl.

Specific examples of the styrene monomer include styrene, alkyl-substituted styrene (for example, α-methylstyrene, 2-methylstyrene, 3-methylstyrene, 4-methylstyrene, 2-ethylstyrene, 3-ethylstyrene, and 4-ethylstyrene), halogen-substituted styrene (for example, 2-chlorostyrene, 3-chlorostyrene, and 4-chlorostyrene), and vinylnaphthalene. These styrene monomers may be used alone or in combination.

Among these, styrene can be used as the styrene monomer from the viewpoints of ease of reaction, ease of controlling the reaction, and availability.

Specific examples of the (meth)acryl monomer include (meth)acrylic acid and (meth)acrylate. Examples of the (meth)acrylate include (meth)acrylic acid alkyl esters (for example, methyl (meth)acrylate, ethyl (meth)acrylate, n-propyl (meth)acrylate, n-butyl (meth)acrylate, n-pentyl (meth)acrylate, n-hexyl acrylate, n-heptyl (meth)acrylate, n-octyl (meth)acrylate, n-decyl (meth)acrylate, n-dodecyl (meth) acrylate, n-lauryl (meth) acrylate, n-tetradecyl (meth) acrylate, n-hexadecyl (meth) acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth) acrylate, isooctyl (meth) acrylate, 2-ethylhexyl (meth)acrylate, cyclohexyl (meth)acrylate, and t-butylcyclohexyl (meth)acrylate), (meth)acrylic acid aryl esters (for example, phenyl (meth)acrylate, biphenyl (meth) acrylate, diphenylethyl (meth) acrylate, t-butylphenyl (meth)acrylate, and terphenyl (meth)acrylate), dimethylaminoethyl (meth) acrylate, diethylaminoethyl (meth) acrylate, methoxyethyl (meth) acrylate, 2-hydroxyethyl (meth)acrylate, β-carboxyethyl (meth)acrylate, and (meth)acrylamide. These (meth)acrylate monomers may be used alone or in combination.

Among these (meth)acrylates serving as the (meth)acryl monomers, (meth)acrylates having an alkyl group having 2 to 14 carbon atoms (preferably 2 to 10 carbon atoms and more preferably 3 to 8 carbon atoms) are preferable from the viewpoint of fixability.

Among these, n-butyl (meth)acrylate is preferable, and n-butyl acrylate is particularly preferable.

The copolymerization ratio of the styrene monomer to the (meth)acryl monomer (mass basis, styrene monomer/(meth)acryl monomer) is not particularly limited and can be 85/15 to 70/30.

The styrene acrylic resin may have a crosslinked structure. An example of the styrene acrylic resin having a crosslinked structure is a resin obtained by copolymerizing at least a styrene monomer, a (meth)acrylic acid monomer, and a crosslinking monomer.

Examples of the crosslinking monomer include difunctional or higher crosslinking agents.

Examples of the difunctional crosslinking agent include divinylbenzene, divinylnaphthalene, di(meth)acrylate compounds (for example, diethylene glycol di(meth)acrylate, methylenebis(meth)acrylamide, decanediol diacrylate, and glycidyl (meth)acrylate), polyester-type di(meth)acrylate, 2-([1′-methylpropylideneamino]carboxyamino)ethyl methacrylate.

Examples of the polyfunctional crosslinking agent include tri(meth)acrylate compounds (for example, pentaerythritol tri(meth)acrylate, trimethylolethane tri(meth)acrylate, and trimethylolpropane tri(meth)acrylate), tetra(meth)acrylate compounds (for example, pentaerythritol tetra(meth)acrylate and oligo ester (meth)acrylate), 2,2-bis(4-methacryloxy, polyethoxyphenyl)propane, diallyl phthalate, triallyl cyanurate, triallyl isocyanurate, triallyl trimellitate, and diallyl chlorendate.

In particular, from the viewpoints of suppressing degradation of the image density and image density nonuniformity, and fixability, the crosslinking monomer is preferably a difunctional or higher (meth)acrylate compound, more preferably a difunctional (meth)acrylate compound, yet more preferably a difunctional (meth)acrylate compound having an alkylene group having 6 to 20 carbon atoms, and particularly preferably a difunctional (meth)acrylate compound having a linear alkylene group having 6 to 20 carbon atoms.

The copolymerization ratio of the crosslinking monomer relative to all monomers (mass basis, crosslinking monomer/all monomers) is not particularly limited and can be 2/1,000 to 20/1,000.

The method for preparing the styrene acrylic resin is not particularly limited, and various polymerization methods (for example, solution polymerization, precipitation polymerization, suspension polymerization, bulk polymerization, and emulsification polymerization) are applied. Known processes (for example, batch, semi-continuous, and continuous methods) are applied to the polymerization reaction.

The styrene acrylic resin preferably accounts for 0 mass % or more and 20 mass % or less, more preferably 1 mass % or more and 15 mass % or less, and yet more preferably 2 mass % or more and 10 mass % or less of the entire binder resin.

The amorphous resin preferably accounts for 60 mass % or more and 98 mass % or less, more preferably 65 mass % or more and 95 mass % or less, and yet more preferably 70 mass % or more and 90 mass % or less of the entire binder resin.

The properties of the amorphous resin will now be described.

The glass transition temperature (Tg) of the amorphous resin is preferably 50° C. or higher and 80° C. or lower and more preferably 50° C. or higher and 65° C. or lower.

The glass transition temperature is determined from a DSC curve obtained by differential scanning calorimetry (DSC), more specifically, according to “extrapolated glass transition onset temperature” described in the method for determining the glass transition temperature in JIS K 7121:1987 “Testing Methods for Transition Temperatures of Plastics”.

The weight average molecular weight (Mw) of the amorphous resin is preferably 5,000 or more and 1,000,000 or less and more preferably 7,000 or more and 500,000 or less.

The number average molecular weight (Mn) of the amorphous resin can be 2,000 or more and 100,000 or less.

The molecular weight distribution Mw/Mn of the amorphous resin is preferably 1.5 or more and 100 or less and more preferably 2 or more and 60 or less.

The weight average molecular weight and the number average molecular weight are measured by gel permeation chromatography (GPC). The molecular weight measurement by GPC is conducted by using GPC.HLC-8120GPC produced by TOSOH CORPORATION as a measuring instrument with columns, TSKgel Super HM-M (15 cm) produced by TOSOH CORPORATION, and a THF solvent. The weight average molecular weight and the number average molecular weight are calculated from the measurement results by using the molecular weight calibration curves obtained from monodisperse polystyrene standard samples.

The crystalline resin will now be described.

Examples of the crystalline resin include known crystalline resins such as a crystalline polyester resin and a crystalline vinyl resin (for example, a polyalkylene resin and a long chain alkyl (meth)acrylate resin). Among these, from the viewpoints of suppressing density nonuniformity and voids in the obtained image, a crystalline polyester resin can be used.

Examples of the crystalline polyester resin include polycondensation products between polycarboxylic acids and polyhydric alcohols. A commercially available crystalline polyester resin or a synthesized crystalline polyester resin may be used as the crystalline polyester resin.

To smoothly form a crystal structure, the crystalline polyester resin can be a polycondensation product obtained by using a linear aliphatic polymerizable monomer rather than a polymerizable monomer having an aromatic ring.

Examples of the polycarboxylic acids include aliphatic dicarboxylic acids (for example, oxalic acid, succinic acid, glutaric acid, adipic acid, suberic acid, azelaic acid, sebacic acid, 1,9-nonandicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, 1 to 5 carbon atoms) alkyl esters thereof.

A dicarboxylic acid and a tri- or higher carboxylic acid having a crosslinked structure or a branched structure may be used in combination as the polycarboxylic acid. Examples of the tricarboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower (for example, 1 to 5 carbon atoms) alkyl esters thereof.

Together with these dicarboxylic acids, a dicarboxylic acid having a sulfonic acid group and a dicarboxylic acid having an ethylenic double bond may be used in combination.

These polycarboxylic acids may be used alone or in combination.

Examples of the polyhydric alcohol include aliphatic diols (for example, linear aliphatic diols having a main chain moiety having 7 to 20 carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, and 1,10-decanediol are preferable as the aliphatic diol.

A trihydric or higher alcohol having a crosslinked structure or a branched structure may be used in combination with a diol in the polyhydric alcohol. Examples of the trihydric or higher alcohol include glycerin, trimethylolethane, trimethylolpropane, and pentaerythritol.

These polyhydric alcohols may be used alone or in combination.

The polyhydric alcohol preferably contains 80 mol % or more and more preferably 90 mol % or more of the aliphatic diol.

The melting temperature of the crystalline polyester resin is preferably 50° C. or higher and 100° C. or lower, more preferably 55° C. or higher and 90° C. or lower, and yet more preferably 60° C. or higher and 85° C. or lower.

The melting temperature of the crystalline polyester resin is determined from a DSC curve obtained by differential scanning calorimetry (DSC) by the method described in “Melting peak temperature”, which is one method for determining the melting temperature in JIS K 7121-1987 “Testing Methods for Transition Temperatures of Plastics”

The weight average molecular weight (Mw) of the crystalline polyester resin can be 6,000 or more and 35,000 or less.

As with the amorphous polyester resin, the crystalline polyester resin is obtained by a known production method.

From the viewpoints of smoothly forming a crystal structure and improving image fixability achieved by good compatibility with the amorphous polyester resin, the crystalline polyester resin can be a polymer formed between α,ω-linear aliphatic dicarboxylic acid and α,ω-linear aliphatic diol.

As α,ω-linear aliphatic dicarboxylic acid, α,ω-linear aliphatic dicarboxylic acid in which the alkylene group linking the two carboxy groups has 3 to 14 carbon atoms is preferable, and the alkylene group more preferably has 4 to 12 carbon atoms, and yet more preferably has 6 to 10 carbon atoms.

Examples of α,ω-linear aliphatic dicarboxylic acid include succinic acid, glutaric acid, adipic acid, 1,6-hexanedicarboxylic acid (also known as suberic acid), 1,7-heptanedicarboxylic acid (also known as azelaic acid), 1,8-octanedicarboxylic acid (also known as sebacic acid), 1,9-nonandicarboxylic acid, 1,10-decanedicarboxylic acid, 1,12-dodecanedicarboxylic acid, 1,14-tetradecanedicarboxylic acid, and 1,18-octadecanedicarboxylic acid. Among these, 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferable.

These α,ω-linear aliphatic dicarboxylic acids may be used alone or in combination.

As α,ω-linear aliphatic diol, α,ω-linear aliphatic diol in which the alkylene group linking the two hydroxy groups has 3 to 14 carbon atoms is preferable, and the alkylene group more preferably has 4 to 12 carbon atoms, and yet more preferably has 6 to 10 carbon atoms.

Examples of the α,ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, and 1,18-octadecanediol, and, among these, 1,6-hexanediol, 1,7-heptanediol, 1,8-octanediol, 1,9-nonanediol, and 1,10-decanediol are preferable.

These α,ω-linear aliphatic diols may be used alone or in combination.

From the viewpoints of smoothly forming a crystal structure and improving image fixability achieved by good compatibility with the amorphous polyester resin, the polymer formed between α,ω-linear aliphatic dicarboxylic acid and α,ω-linear aliphatic diol is preferably a polymer formed between at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1,8-octanediol, 1,9-nonanediol, and 1,10-decanediol, and is more preferably a polymer formed between 1,10-decanedicarboxylic acid and 1,6-hexanediol.

The crystalline resin preferably accounts for 1 mass % or more and 20 mass % or less, more preferably 2 mass % or more and 15 mass % or less, and yet more preferably 3 mass % or more and 10 mass % or less of the entire binder resin.

### Other Binder Resin

Examples of the binder resin include homopolymers obtained from monomers such as ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), olefines (for example, ethylene, propylene, and butadiene), and copolymers obtained from two or more of these monomers.

Other examples of the binder resin include non-vinyl resins such as epoxy resins, polyurethane resins, polyamide resins, cellulose resins, polyether resins, and modified rosin, mixtures of these non-vinyl resins and the aforementioned vinyl resins, and graft polymers obtained by polymerizing a vinyl monomer in the presence of these resins.

These binder resins may be used alone or in combination.

The binder resin content relative to the entire toner particles is preferably 40 mass % or more and 95 mass % or less, more preferably 50 mass % or more and 90 mass % or less, and yet more preferably 60 mass % or more and 85 mass % or less.

### Releasing Agent

In the aggregation step, the dispersion can further contain releasing agent particles.

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters. The releasing agent is not limited to these.

From the viewpoints of suppressing density nonuniformity and voids in the obtained image, and improving image fixability achieved by good compatibility with the amorphous polyester resin, the releasing agent is preferably an ester wax, and more preferably an ester wax obtained from a higher fatty acid having 10 to 30 carbon atoms and a monohydric or polyhydric alcohol component having 1 to 30 carbon atoms.

The ester wax is a wax having an ester bond. The ester wax may be a monoester, a diester, a triester, or a tetraester, and a known natural or synthetic ester wax can be employed.

Examples of the ester wax include ester compounds formed between higher aliphatic acids (aliphatic acids having 10 or more carbon atoms etc.) and monohydric or polyhydric aliphatic alcohols (aliphatic alcohols having 8 or more carbon atoms etc.) and having a melting point of 60° C. or higher and 110° C. or lower (preferably 65° C. or higher and 100° C. or lower and more preferably 70° C. or higher and 95° C. or lower).

Examples of the ester wax include ester compounds obtained from higher aliphatic acids (caprylic acid, capric acid, lauric acid, myristic acid, palmitic acid, stearic acid, arachidic acid, behenic acid, oleic acid, etc.) and alcohols (monohydric alcohols such as methanol, ethanol, propanol, isopropanol, butanol, capryl alcohol, lauryl alcohol, myristyl alcohol, cetyl alcohol, stearyl alcohol, and oleyl alcohol; and polyhydric alcohols such as glycerin, ethylene glycol, propylene glycol, sorbitol, and pentaerythritol), and specific examples of the ester wax include carnauba wax, rice wax, candelilla wax, jojoba wax, wood wax, beeswax, privet wax, lanolin, and montanic acid ester wax.

The melting temperature of the releasing agent is preferably 50° C. or higher and 110° C. or lower and more preferably 60° C. or higher and 100° C. or lower.

The melting temperature of the releasing agent is determined from a DSC curve obtained by differential scanning calorimetry (DSC) by the method described in “Melting peak temperature”, which is one method for determining the melting temperature in JIS K 7121-1987 “Testing Methods for Transition Temperatures of Plastics”

The releasing agent content relative to the entire toner particles is preferably 1 mass % or more and 20 mass % or less and more preferably 5 mass % or more and 15 mass % or less.

### Coloring Agent

In the aggregation step, the dispersion can further contain coloring agent particles.

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent may be surface-treated as necessary, or may be used in combination with a dispersing agent. Multiple coloring agents may be used in combination.

The coloring agent content relative to the entire toner particles is, for example, preferably 1 mass % or more and 30 mass % or less and more preferably 3 mass % or more and 15 mass % or less.

### Other Additives

Examples of other additives include known additives such as magnetic materials, charge controllers, and inorganic powders. These additives are contained in the toner particles as internal additives.

### Properties and Other Features of Toner Particles

The toner particles may have a single layer structure or a core-shell structure constituted by a core (core particles) and a coating layer (shell layer) covering the core (core-shell particles). The toner particles having a core-shell structure is constituted by, for example, a core that contains a binder resin and, optionally, a coloring agent, a releasing agent, etc., and a coating layer that contains a binder resin.

In particular, the toner particles are preferably core-shell-type particles from the viewpoints of low-temperature fixability and suppression of color streaks.

The volume average particle diameter (D₅₀ᵥ) of the toner is preferably 2 μm or more and 10 μm or less and more preferably 4 μm or more and 8 μm or less.

The volume average particle diameter of the toner is measured by using Coulter Multisizer II (produced by Beckman Coulter Inc.) with ISOTON-II (produced by Beckman Coulter Inc.) as the electrolyte.

In measurement, 0.5 mg or more and 50 mg or less of a measurement sample is added to 2 mL of a 5 mass % aqueous solution of a surfactant (for example, sodium alkyl benzenesulfonate) serving as the dispersing agent. The resulting mixture is added to 100 mL or more and 150 mL or less of the electrolyte.

The electrolyte in which the sample has been suspended is dispersed for 1 minute with an ultrasonic disperser, and the particle diameter of each of the particles having a diameter in the range of 2 μm or more and 60 μm or less is measured by using Coulter Multisizer II with apertures having an aperture diameter of 100 μm. The number of particles sampled is 50,000.

For the measured particle diameters, a volume-based cumulative distribution is plotted from the small diameter side, and the particle diameter at 50% accumulation is defined as a volume average particle diameter D₅₀ᵥ.

In this exemplary embodiment, the average circularity of the toner particles is not particularly limited; however, from the viewpoint of improving the cleaning property of the toner from the image carrying body, the average circularity is preferably 0.91 or more and 0.98 or less, more preferably 0.94 or more and 0.98 or less, and yet more preferably 0.95 or more and 0.97 or less.

In this exemplary embodiment, the circularity of a toner particle refers to a value of (perimeter of a circle having the same area as the projected image of the particle)/(perimeter of the projected image of the particle), and the average circularity of the toner particles refers to a circularity at 50% accumulation from the smaller side in the circularity distribution. The average circularity of the toner particles is determined by analyzing at least 3,000 toner particles by using a flow particle image analyzer.

The average circularity of the toner particles can be controlled by, for example, adjusting the speed of stirring the dispersion, the temperature of the dispersion, or the retention time of the dispersion in the fusing step.

### External Additive

The toner produced by the method for producing a toner for developing an electrostatic charge image according to this exemplary embodiment can further include an external additive if needed.

Furthermore, the toner produced by the method for producing a toner for developing an electrostatic charge image according to this exemplary embodiment may be toner particles that have no external additives or toner particles with an external additive externally added thereto.

An example of the external additive is inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surfaces of the inorganic particles used as an external additive may be hydrophobized. Hydrophobizing involves, for example, dipping inorganic particles in a hydrophobizing agent. The hydrophobizing agent is not particularly limited, and examples thereof include a silane coupling agent, a silicone oil, a titanate coupling agent, and an aluminum coupling agent. These may be used alone or in combination.

The amount of the hydrophobizing agent can be 1 part by mass or more and 10 parts by mass or less relative to 100 parts by mass of the inorganic particles.

Examples of the external additive also include resin particles (resin particles of polystyrene, polymethyl methacrylate (PMMA), melamine resin, and the like) and cleaning active agents (for example, particles of higher aliphatic acid metal salts such as zinc stearate and fluorine polymers).

The external addition amount of the external additive is, for example, preferably 0.01 mass % or more and 10 mass % or less and more preferably 0.01 mass % or more and 6 mass % or less relative to the toner particles.

### Electrostatic Charge Image Developer

The electrostatic charge image developer according to an exemplary embodiment contains at least the toner produced by the method for producing a toner for developing an electrostatic charge image according to the exemplary embodiment.

The electrostatic charge image developer of this exemplary embodiment may be a one-component developer that contains only the toner produced by the method for producing a toner for developing electrostatic charge image according to this exemplary embodiment, or may be a two-component developer that is a mixture of the toner and a carrier.

The carrier is not particularly limited, and examples thereof include known carriers. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may be a carrier constituted by cores covered with a coating resin.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, carbon black, titanium oxide, zinc oxide, tin oxide, barium sulfate, aluminum borate, and potassium titanate.

Here, an example of the method for covering the surface of the core with the coating resin is a method that involves coating the surface of the core with a coating layer-forming solution prepared by dissolving the coating resin and, as necessary, various additives in an appropriate solvent. The solvent is not particularly limited and may be selected by taking into account the coating resin to be used, application suitability, etc.

Specific examples of the resin coating method include a dipping method that involves dipping a core in a coating layer-forming solution, a spraying method that involves spraying a coating layer-forming solution onto the surface of a core, a flow bed method that involves spraying a coating layer-forming solution while the core is floated on flowing air, and a kneader coater method that involves mixing the core formed of a carrier and a coating layer-forming solution in a kneader coater and then removing the solvent.

The toner-to-carrier mixing ratio (mass ratio) of the two-component developer is preferably toner:carrier=1:100 to 30:100 and more preferably 3:100 to 20:100.

### Image Forming Apparatus and Image Forming Method

An image forming apparatus and an image forming method according to this exemplary embodiment will now be described.

The image forming apparatus according to this exemplary embodiment includes an image carrying body, a charging unit that charges a surface of the image carrying body, an electrostatic charge image forming unit that forms an electrostatic charge image on the charged surface of the image carrying body, a developing unit that stores the electrostatic charge image developer and develops the electrostatic charge image on the surface of the image carrying body into a toner image by using the electrostatic charge image developer, a transfer unit that transfers the toner image on the surface of the image carrying body onto a surface of a recording medium, and a fixing unit that fixes the transferred toner image onto the surface of the recording medium. The electrostatic charge image developer of this exemplary embodiment is employed as this electrostatic charge image developer.

The image forming apparatus according to this exemplary embodiment is used to perform an image forming method (the image forming method according to this exemplary embodiment) that includes a charging step of charging a surface of an image carrying body, an electrostatic charge image forming step of forming an electrostatic charge image on the charged surface of the image carrying body, a developing step of developing the electrostatic charge image on the surface of the image carrying body into a toner image by using the electrostatic charge image developer of the exemplary embodiment, a transfer step of transferring the toner image on the surface of the image carrying body onto a surface of a recording medium, and a fixing step of fixing the transferred toner image onto the surface of the recording medium.

A known image forming apparatus is applied as the image forming apparatus of this exemplary embodiment. Examples of the known image forming apparatus include a direct transfer type apparatus with which a toner image formed on a surface of an image carrying body is directly transferred onto a recording medium; an intermediate transfer type apparatus with which a toner image formed on a surface of an image carrying body is first transferred onto a surface of an intermediate transfer body and then the toner image on the intermediate transfer body is transferred for the second time onto a surface of a recording medium; an apparatus equipped with a cleaning unit that cleans the surface of an image carrying body after the toner image transfer and before charging; and an apparatus equipped with a charge erasing unit that irradiates the surface of an image carrying body with charge erasing light to remove charges after the toner image transfer and before charging.

Among these, an image forming apparatus equipped with a cleaning unit that cleans the surface of the image carrying body is suitable. The cleaning unit can be a cleaning blade.

When an intermediate transfer type apparatus is to be employed, the transfer unit is equipped with, for example, an intermediate transfer body having a surface onto which a toner image is transferred, a first transfer unit that transfers the toner image on the surface of the image carrying body onto the surface of the intermediate body, and a second transfer unit that transfers the toner image on the surface of the intermediate transfer body onto a surface of a recording medium.

In the image forming apparatus of this exemplary embodiment, for example, a section that includes the developing unit may have a cartridge structure (process cartridge) that can be attached to and detached from the image forming apparatus. For example, the process cartridge can be equipped with a developing unit that stores the electrostatic charge image developer of the exemplary embodiment.

Hereinafter, one example of the image forming apparatus of the exemplary embodiment is described, but the image forming apparatus is not limited by the description below. The relevant parts illustrated in the drawings are described, and description of other parts is omitted.

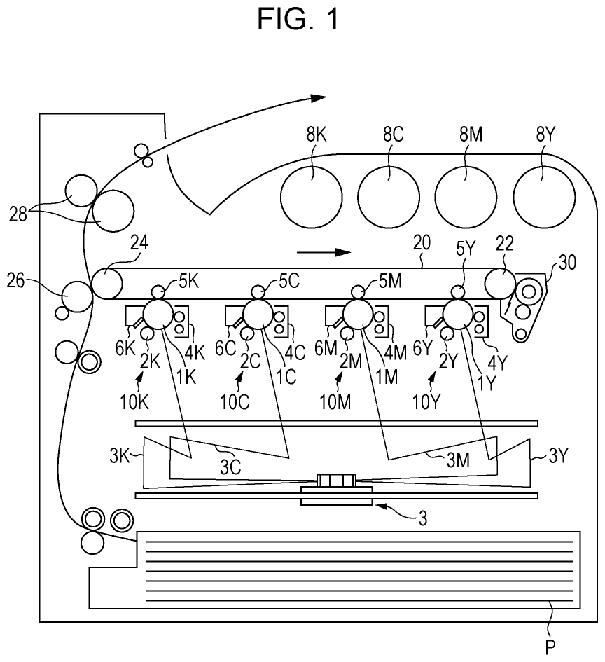

FIG. 1 is a schematic diagram illustrating an image forming apparatus according to an exemplary embodiment.

The image forming apparatus illustrated in FIG. 1 is equipped with first to fourth image forming units 10Y, 10M, 10C, and 10K (image forming units) of an electrophotographic type configured to output images of respective colors, yellow (Y), magenta (M), cyan (C), and black (K), on the basis of the color separated image data. These image forming units (hereinafter may be simply referred to as “units”) 10Y, 10M, 10C, and 10K are disposed side-by-side separated from each other by a predetermined distance in the horizontal direction. These units 10Y, 10M, 10C, and 10K may be process cartridges that can be attached to and detached from the image forming apparatus.

An intermediate transfer belt 20 that serves as an intermediate transfer body for all of the units 10Y, 10M, 10C, and 10K extends above the units 10Y, 10M, 10C, and 10K as viewed in the drawing. The intermediate transfer belt 20 is wound around a drive roll 22 and a support roll 24 that are arranged to be spaced from each other in the left-to-right direction in the drawing. The support roll 24 is in contact with the inner surface of the intermediate transfer belt 20, and the intermediate transfer belt 20 runs in a direction from the first unit 10Y toward the fourth unit 10K. A force that urges the support roll 24 to move in a direction away from the drive roll 22 is applied to the support roll 24 by a spring or the like not illustrated in the drawing so that a tension is applied to the intermediate transfer belt 20 wound around the support roll 24 and the drive roll 22. In addition, an intermediate transfer body cleaning device 30 that faces the drive roll 22 is disposed on the surface of the intermediate transfer belt 20 that carries the images.

Toners of four colors, yellow, magenta, cyan, and black, are stored in toner cartridges 8Y, 8M, 8C, and 8K and supplied to developing devices (developing units) 4Y, 4M, 4C, and 4K of the units 10Y, 10M, 10C, and 10K.

Since the first to fourth units 10Y, 10M, 10C, and 10K are identical in structure, only the first unit 10Y that forms a yellow image and is disposed on the upstream side of the intermediate transfer belt running direction is described as a representative example in the description below. Note that parts equivalent to those of the first unit 10Y are referred by reference signs having magenta (M), cyan (C), or black (K) added thereto instead of yellow (Y) to omit the descriptions of the second to fourth units 10M, 10C, and 10K.

The first unit 10Y has a photoreceptor 1Y that serves as an image carrying body. A charging roll (one example of the charging unit) 2Y that charges the surface of the photoreceptor 1Y to a predetermined potential, the exposing device (one example of the electrostatic charge image forming unit) 3 that forms an electrostatic charge image by exposing the charged surface with a laser beam 3Y on the basis of a color-separated image signal, a developing device (one example of the developing unit) 4Y that develops the electrostatic charge image by supplying the charged toner to the electrostatic charge image, a first transfer roll 5Y (one example of the first transfer unit) that transfers the developed toner image onto the intermediate transfer belt 20, and a photoreceptor cleaning device (one example of the cleaning unit) 6Y that removes the toner remaining on the surface of the photoreceptor 1Y after the first transfer are arranged in the order around the photoreceptor 1Y.

The first transfer roll 5Y is disposed on the inner side of the intermediate transfer belt 20 and faces the photoreceptor 1Y. Furthermore, each of the first transfer rolls 5Y, 5M, 5C, and 5K is connected to a bias power supply (not illustrated) that applies a first transfer bias. The bias power supplies control and vary the transfer biases to be applied to the respective first transfer rolls by controllers not illustrated in the drawing.

Hereinafter, the operation of forming a yellow image in the first unit 10Y is described.

First, prior to the operation, the surface of the photoreceptor 1Y is charged to a potential of −600 V to −800 V by the charging roll 2Y.

The photoreceptor 1Y is formed by forming a photosensitive layer on a conductive (for example, the volume resistivity of 1×10⁻⁶ Ωcm or less at 20° C.) substrate. This photosensitive layer usually has high resistance (resistance of resins in general) but has a property that the part irradiated with a laser beam 3Y undergoes a change in resistivity. Thus the laser beam 3Y is output toward the charged surface of the photoreceptor 1Y through the exposing device 3 according to the yellow image data sent from a controller not illustrated in the drawing. The laser beam 3Y irradiates the photosensitive layer on the surface of the photoreceptor 1Y and thereby forms an electrostatic charge image of a yellow image pattern on the surface of the photoreceptor 1Y.

The electrostatic charge image is an image formed on the surface of the photoreceptor 1Y as a result of charging, and is a so-called negative latent image formed by the charges remaining in the portion of the photosensitive layer not irradiated with the laser beam 3Y as the charges on the surface of the photoreceptor 1Y in the portion of the photosensitive layer irradiated with the laser beam 3Y flow due to the decreased resistivity of the irradiated portion.

The electrostatic charge image on the photoreceptor 1Y is rotated to a predetermined development position as the photoreceptor 1Y is run. Then at this development position, the electrostatic charge image on the photoreceptor 1Y is visualized (developed image) into a toner image by the developing device 4Y.

For example, an electrostatic charge image developer that contains at least a yellow toner and a carrier is stored in the developing device 4Y. The yellow toner is frictionally charged by being stirred in the developing device 4Y and is carried on a developer roll (an example of a developer carrying member) by having charges of the same polarity (negative polarity) as the charges on the photoreceptor 1Y. Then as the surface of the photoreceptor 1Y passes the developing device 4Y, the yellow toner electrostatically adheres to the latent image portion from which the charges on the surface of the photoreceptor 1Y have been removed, and thus the latent image is developed with the yellow toner. The photoreceptor 1Y on which the yellow toner image has been formed is continuously run at a predetermined speed, and the toner image developed on the photoreceptor 1Y is conveyed to a predetermined first transfer position.

As the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite of the polarity (−) of the toner, and, for example, the transfer bias is controlled to +10 μA by a controller (not illustrated) in the first unit 10Y.

Meanwhile, the toner remaining on the photoreceptor 1Y is removed and recovered by the photoreceptor cleaning device 6Y.

The first transfer biases applied to the first transfer rolls 5M, 5C, and 5K of the second unit 10M and onward are controlled in accordance with the first unit.

As such, the intermediate transfer belt 20 onto which the yellow toner image has been transferred in the first unit 10Y is sequentially conveyed through the second to fourth units 10M, 10C, and 10K, and toner images of respective colors are superimposed on each other (multiple transfer).

The intermediate transfer belt 20 onto which the toner images of four colors have been transferred through the first to fourth units reaches a second transfer section constituted by the intermediate transfer belt 20, the support roll 24 in contact with the inner surface of the intermediate transfer belt 20, and a second transfer roll (one example of the second transfer unit) 26 disposed on the image-carrying surface-side of the intermediate transfer belt 20. Meanwhile, a supplying mechanism supplies a recording sheet (one example of the recording medium) P, at a predetermined timing, to a gap between the second transfer roll 26 and the intermediate transfer belt 20 in contact with each other, and a second transfer bias is applied to the support roll 24. The transfer bias applied at this stage has the same polarity (−) as the polarity (−) of the toner, and an electrostatic force acting from the intermediate transfer belt 20 toward the recording sheet P acts on the toner image, and the toner image on the intermediate transfer belt is transferred onto the recording sheet P. Here, the second transfer bias is determined on the basis of the resistance detected with a resistance detection unit (not illustrated) that detects the resistance of the second transfer section, and is voltage-controlled.

Subsequently, the recording sheet P is sent into a contact section (nip section) between a pair of fixing rolls of a fixing device (one example of the fixing unit) 28, and the toner image is fixed onto the recording sheet P to form a fixed image.

Examples of the recording sheet P used to transfer the toner image include regular paper used in electrophotographic copier and printers, etc. The recording medium may be OHP sheets and the like instead of the recording sheet P.

In order to further improve the smoothness of the image surface after fixing, the surface of the recording sheet P can also be smooth, and examples of such a recording sheet P include coated paper obtained by coating the surface of regular paper with a resin or the like, and art paper used in printing.

The recording sheet P after completion of fixing of the color image is conveyed toward a discharge section, thereby terminating a series of color image forming operations.

### Process Cartridge and Toner Cartridge

A process cartridge according to an exemplary embodiment will now be described.

The process cartridge of this exemplary embodiment is equipped with a developing unit that stores the electrostatic charge image developer of the exemplary embodiment and develops an electrostatic charge image on the surface of an image carrying body into a toner image by using the electrostatic charge image developer, and is detachably attachable to an image forming apparatus.

The process cartridge of this exemplary embodiment is not limited to the aforementioned structure, and may be have a structure that includes a developing device and, if needed, at least one selected from other units, for example, an image carrying body, a charging unit, an electrostatic charge image forming unit, and a transfer unit.

Hereinafter, one example of the process cartridge according to the exemplary embodiment is described, but the process cartridge is not limited by the description below. The relevant parts illustrated in the drawings are described, and description of other parts is omitted.

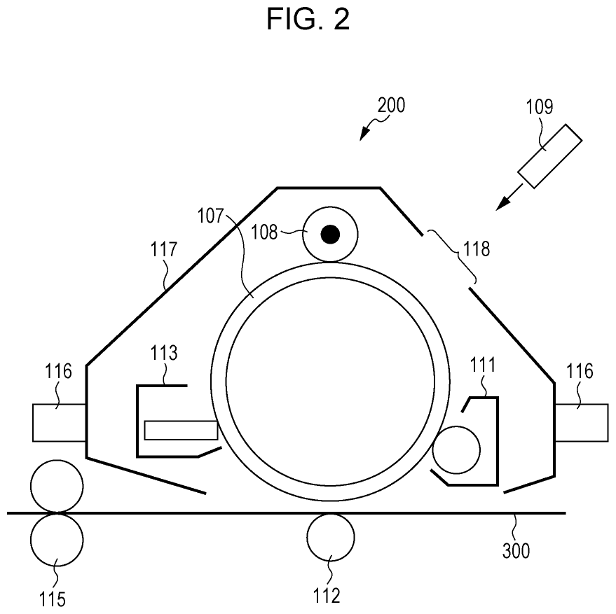

FIG. 2 is a schematic diagram illustrating a process cartridge of an exemplary embodiment.

A process cartridge 200 illustrated in FIG. 2 is constituted by a casing 117 equipped with a guide rail 116 and an opening 118 for exposure, the casing integrating a photoreceptor 107 (one example of the image carrying body), a charging roll 108 (one example of the charging unit) disposed around the photoreceptor 107, a developing unit 111 (one example of the developing unit), and a photoreceptor cleaning unit 113 (one example of the cleaning unit) to form a cartridge.

Note that in FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge of this exemplary embodiment stores the toner of the exemplary embodiment and is detachably attachable to an image forming apparatus. The toner cartridge stores replenishment toner to be supplied to the developing unit in the image forming apparatus.

The image forming apparatus illustrated in FIG. 1 is of a type that the toner cartridges 8Y, 8M, 8C, and 8K are detachably attachable, and the developing devices 4Y, 4M, 4C, and 4K are respectively connected to the toner cartridges corresponding to the respective developing devices (colors) through toner supply tubes. Moreover, when the toner in the toner cartridge runs low, the toner cartridge is replaced.

### EXAMPLES

Hereinafter the exemplary embodiments are specifically described in details through examples and comparative examples which do not limit the scope of the exemplary embodiments. Note that the “parts” and “%” indicating amounts are on a mass basis unless otherwise noted.

Synthesis of amorphous polyester resin (A)
terephthalic acid: 690 parts
fumaric acid: 310 parts
ethylene glycol: 400 parts
1,5-pentanediol: 450 parts

The aforementioned materials are placed in a reaction vessel equipped with a stirrer, a nitrogen inlet tube, a temperature sensor, and a distillation column, the temperature is elevated to 220° C. over a period of 1 hour under nitrogen gas stream, and 10 parts of titanium tetraethoxide is added to a total of 1,000 parts of the aforementioned materials. The temperature is elevated to 240° C. over a period of 0.5 hours while distilling away the generated water, dehydration and condensation reaction is continued for 1 hour at 240° C., and then the reaction product is cooled. As a result, an amorphous polyester resin (A) having a weight-average molecular weight of 96000 and a glass transition temperature of 59° C. is obtained.

Synthesis of amorphous polyester resin (B)
terephthalic acid: 690 parts
trimellitic acid: 310 parts
ethylene glycol: 400 parts
1,5-pentanediol: 450 parts

The aforementioned materials are placed in a flask equipped with a stirrer, a nitrogen inlet tube, a temperature sensor, and a distillation column, the temperature is elevated to 220° C. over a period of 1 hour under nitrogen gas stream, and 10 parts of titanium tetraethoxide is added to a total of 1,000 parts of the aforementioned materials. The temperature is elevated to 240° C. over a period of 0.5 hours while distilling away the generated water, dehydration and condensation reaction is continued for 1 hour at 240° C., and then the reaction product is cooled. As a result, an amorphous polyester resin (B) having a weight-average molecular weight of 127,000 and a glass transition temperature of 59° C. is obtained.

### Preparation of Amorphous Polyester Resin Particle Dispersion (A1)

Into a vessel equipped with a temperature adjusting unit and a nitrogen purging unit, 550 parts of ethyl acetate and 250 parts of 2-butanol are placed to prepare a mixed solvent, and then 1,000 parts of the amorphous polyester resin (A) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the container is substituted with dry nitrogen, the temperature is retained at 40° C., and 4,000 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 160 nm is obtained. To this resin particle dispersion, ion exchange water is added to adjust the solid content to 20% so as to obtain an amorphous polyester resin particle dispersion (A1).

The zeta potential of the amorphous polyester resin particle dispersion (A1) measured is −40 mV.

### Preparation of Amorphous Polyester Resin Particle Dispersion (B1)

An amorphous polyester resin particle dispersion (B1) having a volume-average particle diameter of 80 nm and a solid content of 20% is obtained as with the amorphous polyester resin particle dispersion (A1) except that 1,000 parts of the amorphous polyester resin (A) is changed to 1,000 parts of the amorphous polyester resin (B).

The zeta potential of the amorphous polyester resin particle dispersion (B1) measured is −40 mV.

### Preparation of Crystalline Polyester Resin Particle Dispersion (D1)

1,10-decanedicarboxylic acid: 2,600 parts
1,6-hexanediol: 1,670 parts
dibutyl tin oxide (catalyst): 3 parts

The aforementioned materials are placed in a heated and dried reaction vessel, the air inside the reaction vessel is purged with nitrogen gas to create an inert atmosphere, and the resulting mixture is mechanically stirred and refluxed at 180° C. for 5 hours. Next, the temperature is gradually elevated to 230° C. at a reduced pressure, stirring is continued for 2 hours, and the mixture is air-cooled after the mixture has turned viscous to terminate the reaction. As a result, a crystalline polyester resin having a weight-average molecular weight of 12,600 and a melting temperature of 73° C. is obtained. A mixture containing 900 parts of the crystalline polyester resin, 18 parts of an anionic surfactant (TaycaPower produced by TAYCA Co., Ltd.), and 2,100 parts of ion exchange water is heated to 120° C., dispersed by using a homogenizer (ULTRA-TURRAX T50 produced by IKA Japan), and then dispersed by a pressure discharge Gaulin homogenizer for 1 hour. As a result, a resin particle dispersion in which resin particles having a volume-average particle diameter of 160 nm are dispersed is obtained. To this resin particle dispersion, ion exchange water is added to adjust the solid content to 20% so as to obtain a crystalline polyester resin particle dispersion (D1).

The zeta potential of the crystalline polyester resin particle dispersion (D1) measured is −40 mV.

### Preparation of Styrene Acrylic Resin Particle Dispersion (S1)

styrene: 3,750 parts
n-butyl acrylate: 250 parts
acrylic acid: 20 parts
dodecanethiol: 240 parts
carbon tetrabromide: 40 parts

In a reaction vessel, a mixture prepared by mixing and dissolving the aforementioned materials is dispersed and emulsified with a surfactant solution prepared by dissolving 60 parts of a nonionic surfactant (NONIPOL 400 produced by Sanyo Chemical Industries Ltd.) and 100 parts of an anionic surfactant (TaycaPower produced by TAYCA Co., Ltd.) in 5,500 parts of ion exchange water. Next, while the inside of the reaction vessel is stirred, an aqueous solution prepared by dissolving 40 parts of ammonia persulfate in 500 parts of ion exchange water is added over a period of 20 minutes. Next, after nitrogen purging, while the inside of the reaction vessel is stirred, the content thereof is heated until 70° C., and the temperature of 70° C. is retained for 5 hours to continue emulsification polymerization. Thus, a resin particle dispersion containing dispersed resin particles having a volume-average particle diameter of 160 nm is obtained. To this resin particle dispersion, ion exchange water is added to adjust the solid content to 20%, and as a result, a styrene acrylic resin particle dispersion (S1) is obtained.

The zeta potential of the styrene acrylic resin particle dispersion (S1) measured is −40 mV.

### Preparation of Releasing Agent Particle Dispersion (W1)

paraffin wax (FNP92 produced by produced by Nippon Seiro Co., Ltd., melting temperature: 92° C.): 1,000 parts
anionic surfactant (TaycaPower produced by TAYCA Co., Ltd.): 10 part
ion exchange water: 3,500 parts

The aforementioned materials are mixed, heated to 100° C., dispersed by using a homogenizer (ULTRA-TURRAX T50 produced by IKA Japan), and then dispersed by a pressure discharge Gaulin homogenizer. As a result, a releasing agent particle dispersion in which releasing agent particles having a volume-average particle diameter of 220 nm are dispersed is obtained. To this releasing agent particle dispersion, ion exchange water is added to adjust the solid content to 20% so as to obtain a releasing agent particle dispersion (W1).

The zeta potential of the releasing agent particle dispersion (W1) measured is −70 mV.

### Preparation of Black Coloring Particle Dispersion (K1)

carbon black (Regal 330 produced by Cabot Corporation): 500 parts
ionic surfactant NEOGEN RK (produced by DKS Co. Ltd.): 50 parts
ion exchange water: 1,930 parts

The aforementioned materials are mixed and dispersed with an Ultimaizer (produced by SUGINO MACHINE LIMITED) at 240 MPa for 10 minutes so as to prepare a black coloring particle dispersion (K1) (solid component concentration: 20%).

The zeta potential of the black coloring particle dispersion (K₁) measured is −30 mV.

### Example 1

### Preparation of Toner Particles

ion exchange water: 3,500 parts
amorphous polyester resin dispersion (A1): 2,630 parts
amorphous polyester resin dispersion (B1): 2,630 parts
crystalline polyester resin dispersion (D1): 1,500 parts
styrene acrylic resin particle dispersion (S1): 750 parts
black coloring particle dispersion (K1): 1,500 parts
releasing agent particle dispersion (W1): 1,500 parts

The aforementioned materials are placed in a stirring vessel equipped with a heating jacket and two-stage four-paddle blade stirring device, the pH is adjusted to 3.9 by adding 0.1 N (=0.1 mol/L) nitric acid, and then the bottom portion of the stirring vessel is connected to a dispersing machine (Cavitron CD1010 produced by Pacific Machinery & Engineering Co., Ltd.) via a guide pipe and a circulating pump. A guide pipe from the discharge port of the dispersing machine is immersed in the liquid in the stirring vessel from above the stirring vessel to form a circulating system. As the mixed solution is being dispersed while being circulated at 1,500 kg/min, an aqueous aluminum sulfate solution prepared by dissolving 30 parts of aluminum sulfate in 1,970 parts of ion exchange water is added at a rate of 90 kg/min from a position 30D between the bottom portion of the stirring vessel and the inlet of the dispersing machine, where D represents the inner diameter of the pipe connected to the dispersing machine. After the addition of the aqueous solution, the mixed solution is kept circulating for 10 minutes while maintaining 30° C. to continue dispersing. Subsequently, the dispersing machine is stopped, the bottom valve at the bottom portion of the stirring vessel is closed, and 1,500 parts of ion exchange water is added thereto from the position where the aggregating agent aqueous solution is added while continuing circulation. The guide pipe is removed, and the aggregated particle dispersion is heated to 45° C. with the heating jacket, and retained thereat until the volume-average particle diameter reaches 4.0 μm.

Next, a mixture containing 2,250 parts of the amorphous polyester resin particle dispersion (A1) and 2,250 parts of the amorphous polyester resin particle dispersion (B1) is added thereto, and the resulting mixture is retained for 30 minutes. Next, the pH is adjusted to 9.0 by using a 1 N (=1 mol/L) aqueous sodium hydroxide solution.

While continuing the stirring, the temperature is elevated at a rate of 0.05° C./min up to 85° C., retained at 85° C. for 3 hours, and then decreased at a rate of 15° C./min to 30° C. (first cooling). Next, the temperature is elevated at a rate of 0.2° C./min up to 55° C. (reheating), retained thereat for 30 minutes, and then decreased at a rate of 0.5° C./min to 30° C. (second cooling).

Next, the solid components are separated by filtration, washed with ion exchange water, and dried. As a result, toner particles (K1) having a volume-average particle diameter of 5.0 μm are obtained.

### External Addition of External Additive

One hundred parts of the toner particles (K1) and 1.5 parts of hydrophobic silica (RY 50 produced by Nippon Aerosil Co., Ltd.) are mixed, and the resulting mixture is mixed for 30 seconds at a rotation rate of 10,000 rpm with a sample mill. The resulting product is sieved through a vibrating sieve having 45 μm openings to prepare a toner (K1) (toner for developing an electrostatic charge image). The volume average particle diameter of the toner (K1) is 5.0 μm.

### Preparation of Carrier

After 500 parts of spherical magnetite powder particles (volume average particle diameter: 0.55 μm) are thoroughly stirred in a HENSCHEL mixer, 5 parts of a titanate coupling agent is added, and the resulting mixture is heated to 100° C. and then stirred for 30 minutes. Next, into a four-necked flask, 6.25 parts of phenol, 9.25 parts of 35% formalin, 500 parts of the magnetite particles treated with the titanate coupling agent, 6.25 parts of 25% ammonia water, and 425 parts of water are placed, and the resulting mixture is stirred, and reacted at 85° C. for 120 minutes under stirring. Next, after cooling to 25° C., 500 parts of water is added thereto, the supernatant is removed, and the deposits are washed with water. The washed deposits are dried by heating at a reduced pressure so as to obtain a carrier (CA) having an average particle diameter of 35 μm.

### Mixing Toner and Carrier

The toner (K1) and the carrier (CA) are placed in a V blender at toner (K1):carrier (CA)=5:95 (mass ratio), and the resulting mixture is stirred for 20 minutes. As a result, a developer (K1) (electrostatic charge image developer) is obtained.

### Evaluation

The obtained developer is loaded into a developing device of an image forming apparatus (modified model of DocuCentre-IV C5570 produced by Fuji Xerox Co., Ltd.).

### Evaluation of Property of Suppressing Image Density Nonuniformity

An image having an image density of 30% is output on 100 sheets in a low-temperature, low-humidity environment (10° C., 15% RH). For each of the output images, the image density is measured at randomly selected ten points by using an image densitomer X-Rite 938 (produced by X-Rite Inc.), the image density difference between the maximum measured value and the minimum measured value is determined, and the image density nonuniformity is evaluated according to the following criteria:

A: The image density difference is 0.2 or less.

B: The image density difference is more than 0.2 but 0.25 or less.

C: The image density difference is more than 0.25 but 0.3 or less.

D: The image density difference is more than 0.3.

### Example 2

A developer is obtained as in Example 1 except that, in preparing the aggregating agent aqueous solution, 30 parts of aluminum sulfate is dissolved in 640 parts of ion exchange water, and evaluation is conducted as in Example 1.

### Example 3

A developer is obtained as in Example 1 except that, in preparing the aggregating agent aqueous solution, 30 parts of aluminum sulfate is dissolved in 5,970 parts of ion exchange water, and evaluation is conducted as in Example 1.

### Example 4

A developer is obtained as in Example 1 except that the rate of adding the aggregating agent aqueous solution is changed to 150 kg/min, and evaluation is conducted as in Example 1.

### Example 5

A developer is obtained as in Example 1 except that the rate of adding the aggregating agent aqueous solution is changed to 15 kg/min, and evaluation is conducted as in Example 1.

### Example 6

### Preparation of Releasing Agent Particle Dispersion (W2)

paraffin wax (FNP92 produced by produced by Nippon Seiro Co., Ltd., melting temperature: 92° C.): 1,000 parts
anionic surfactant (PELEX SS-H produced by Kao Corporation): 10 parts
ion exchange water: 3,500 parts

The aforementioned materials are mixed, heated to 100° C., dispersed by using a homogenizer (ULTRA-TURRAX T50 produced by IKA Japan), and then dispersed by a pressure discharge Gaulin homogenizer. As a result, a releasing agent particle dispersion in which releasing agent particles having a volume-average particle diameter of 220 nm are dispersed is obtained. To this releasing agent particle dispersion, ion exchange water is added to adjust the solid content to 20% so as to obtain a releasing agent particle dispersion (W2).

The zeta potential of the releasing agent particle dispersion (W2) measured is −40 mV.

A developer is obtained as in Example 1 except that, in preparing toner particles, the releasing agent particle dispersion (W2) is used instead of the releasing agent particle dispersion (W1), and evaluation is conducted as in Example 1.

### Example 7

### Preparation of Styrene Acrylic Resin Particle Dispersion (S2)

styrene: 6,250 parts
n-butyl acrylate: 750 parts
acrylic acid: 140 parts
dodecanethiol: 275 parts
carbon tetrabromide: 75 parts

In a reaction vessel, a mixture prepared by mixing and dissolving the aforementioned materials is dispersed and emulsified with a surfactant solution prepared by dissolving 110 parts of a nonionic surfactant (NONIPOL 400 produced by Sanyo Chemical Industries Ltd.) and 150 parts of an anionic surfactant (sodium dodecylbenzenesulfonate, NEOGEN R, produced by DKS Co., Ltd.) in 8,750 parts of ion exchange water. Next, while the inside of the reaction vessel is stirred, an aqueous solution prepared by dissolving 75 parts of ammonia persulfate in 1,750 parts of ion exchange water is added over a period of 20 minutes. Next, after nitrogen purging, while the inside of the reaction vessel is stirred, the content thereof is heated until 70° C., and the temperature of 70° C. is retained for 6 hours to continue emulsification polymerization. Thus, a styrene acrylic resin particle dispersion (S2) containing dispersed resin particles having a volume-average particle diameter of 155 nm is obtained.

The zeta potential of the styrene acrylic resin particle dispersion (S2) measured is −40 mV.

### Preparation of Styrene Acrylic Resin Particle Dispersion (S3)

styrene: 4,850 parts
n-butyl acrylate: 2,075 parts
acrylic acid: 145 parts

In a reaction vessel, a mixture prepared by mixing and dissolving the aforementioned materials is dispersed and emulsified with a surfactant solution prepared by dissolving 110 parts of a nonionic surfactant (NONIPOL 400 produced by Sanyo Chemical Industries Ltd.) and 225 parts of an anionic surfactant (sodium dodecylbenzenesulfonate, NEOGEN R, produced by DKS Co., Ltd.) in 8,750 parts of ion exchange water. Next, while the inside of the reaction vessel is stirred, an aqueous solution prepared by dissolving 40 parts of ammonia persulfate in 1,750 parts of ion exchange water is added over a period of 20 minutes. Next, after nitrogen purging, while the inside of the reaction vessel is stirred, the content thereof is heated until 70° C., and the temperature of 70° C. is retained for 6 hours to continue emulsification polymerization. Thus, a styrene acrylic resin particle dispersion (S3) containing dispersed resin particles having a volume-average particle diameter of 100 nm is obtained.

The zeta potential of the styrene acrylic resin particle dispersion (S3) measured is −50 mV.

### Preparation of Toner Particles

ion exchange water: 9,000 parts
resin particle dispersion (S2): 2,100 parts
resin particle dispersion (S3): 1,380 parts
black coloring particle dispersion (K1): 525 parts
releasing agent particle dispersion (W1): 700 parts

The aforementioned materials are placed in a stirring vessel equipped with a heating jacket, and then the bottom portion of the stirring vessel is connected to a dispersing machine (Cavitron CD1010 produced by Pacific Machinery & Engineering Co., Ltd.) via a guide pipe and a circulating pump. A guide pipe from the discharge port of the dispersing machine is immersed in the liquid in the stirring vessel from above the stirring vessel to form a circulating system. As the mixed solution is being dispersed while being circulated at 1,500 kg/min, an aqueous aluminum sulfate solution prepared by dissolving 20 parts of aluminum sulfate in 1,310 parts of ion exchange water is added at a rate of 90 kg/min from a position 30D between the bottom portion of the stirring vessel and the inlet of the dispersing machine, where D represents the inner diameter of the pipe connected to the dispersing machine. Next, the dispersion is heated to 48° C. with the heating jacket of the stirring vessel, and retained thereat for 60 minutes. To this dispersion, 1,080 parts of the resin particle dispersion (S2) is gradually added, and the resulting mixture is retained for another 1 hour. Next, to this dispersion, 375 parts of a 4% aqueous sodium hydroxide solution is added, the resulting mixture is heated to 97° C., 250 parts of a 2% aqueous nitric acid solution is added thereto, and the resulting mixture is retained for 6 hours to fuse the aggregated particles. Next, the solid components are separated by filtration, washed with ion exchange water, and dried. As a result, toner particles having a volume-average particle diameter of 5.0 μm are obtained.

A developer is then prepared as in Example 1, and evaluation is conducted as in Example 1.

### Example 8

A developer is obtained as in Example 1 except that polyaluminum chloride is used as the aggregating agent instead of aluminum sulfate, and evaluation is conducted as in Example 1.

### Example 9

A developer is obtained as in Example 1 except that magnesium chloride is used as the aggregating agent instead of aluminum sulfate, and evaluation is conducted as in Example 1.

### Example 10

A developer is obtained as in Example 1 except that, in preparing the aggregating agent aqueous solution, 90 parts of aluminum sulfate is dissolved in 5,910 parts of ion exchange water, and evaluation is conducted as in Example 1.

### Example 11

A developer is obtained as in Example 1 except that a stirring vessel equipped with a heating jacket and a turbine blade is used as the stirring device during the aggregation, and evaluation is conducted as in Example 1.

### Comparative Example 1

A developer is obtained as in Example 1 except that, in preparing the aggregating agent aqueous solution, 30 parts of aluminum sulfate is dissolved in 270 parts of ion exchange water, and evaluation is conducted as in Example 1.

### Comparative Example 2

A developer is obtained as in Example 1 except that, in preparing the aggregating agent aqueous solution, 3 parts of aluminum sulfate is dissolved in 3,747 parts of ion exchange water, and evaluation is conducted as in Example 1.

### Comparative Example 3

A developer is obtained as in Example 1 except that the rate of adding the aggregating agent aqueous solution is changed to 300 kg/min, and evaluation is conducted as in Example 1.

### Comparative Example 4

A developer is obtained as in Example 1 except that the rate of adding the aggregating agent aqueous solution is changed to 10 kg/min, and evaluation is conducted as in Example 1.

TABLE

| | | | | | | | Total amount of | |
|---|---|---|---|---|---|---|---|---|
| | | | | | | | aggregating | |
| | Aggregating agent | | Minimum value | | | | agent added | Evaluation of |
| | concentration of | | among zeta | | | Shape of stirring | relative to total | property of |
| | aggregating agent | | potentials of | Binder resin | | blade of stirring | mass of toner | suppressing |
| | aqueous solution | | dispersions | (base | Aggregating | device used in | particles | image density |
| | (mass %) | q/Q | (mV) | component) | agent | aggregation | (mass %) | nonuniformity |
| Example 1 | 1.5 | 0.06 | −70 | PES | Al sulfate | Paddle | 1 | A |
| Example 2 | 4.5 | 0.06 | −70 | PES | Al sulfate | Paddle | 1 | B |
| Example 3 | 0.5 | 0.06 | −70 | PES | Al sulfate | Paddle | 1 | B |
| Example 4 | 1.5 | 0.10 | −70 | PES | Al sulfate | Paddle | 1 | B |
| Example 5 | 1.5 | 0.01 | −70 | PES | Al sulfate | Paddle | 1 | A |
| Example 6 | 1.5 | 0.06 | −40 | PES | Al sulfate | Paddle | 1 | B |
| Example 7 | 1.5 | 0.06 | −70 | St-Ac | Al sulfate | Paddle | 1 | B |
| Example 8 | 1.5 | 0.06 | −70 | PES | PAC | Paddle | 1 | C |
| Example 9 | 1.5 | 0.06 | −70 | PES | Ca chloride | Paddle | 1 | C |
| Example 10 | 1.5 | 0.06 | −70 | PES | Al sulfate | Paddle | 3 | C |
| Example 11 | 1.5 | 0.06 | −70 | PES | Al sulfate | Turbine | 1 | C |
| Comparative | 10 | 0.06 | −70 | PES | Al sulfate | Paddle | 1 | D |
| Example 1 | | | | | | | | |
| Comparative | 0.08 | 0.06 | −70 | PES | Al sulfate | Paddle | 0.1 | D |
| Example 2 | | | | | | | | |
| Comparative | 1.5 | 0.20 | −70 | PES | Al sulfate | Paddle | 1 | D |
| Example 3 | | | | | | | | |
| Comparative | 1.5 | 0.007 | −70 | PES | Al sulfate | Paddle | 1 | D |
| Example 4 | | | | | | | | |

In Table, PES denotes a polyester resin, St-Ac denotes a styrene acrylic resin, Al sulfate denotes aluminum sulfate, PAC denotes polyaluminum chloride, and Ca chloride denotes calcium chloride.

These results show that a toner for developing an electrostatic charge image, the toner having an excellent property of suppressing image density nonuniformity in the obtained image, is obtained in Examples compared to Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for producing a toner for developing an electrostatic charge image, comprising:
aggregating at least resin particles contained in a dispersion to form aggregated particles; and
heating and fusing the aggregated particles to form fused particles, wherein:
in the aggregating, aggregation is performed by taking out a portion of the dispersion containing the resin particles mixed in a stirring vessel, adding an aggregating agent aqueous solution thereto, passing the resulting mixture through a dispersing machine, and then returning the resulting mixture to the stirring vessel so as to circulate the dispersion, and
when adding the aggregating agent aqueous solution, an aqueous solution containing an aggregating agent at a concentration of 0.1 mass % or more and 5 mass % or less is added at a flow rate q (L/min) such that a ratio of this flow rate q (L/min) to a flow rate Q (L/min) of the mixture returning from the dispersing machine to the stirring vessel is 0.01 or more and 0.1 or less.

2. The method for producing a toner for developing an electrostatic static charge image according to claim 1, wherein, in the aggregating, the dispersion is obtained by mixing at least a resin particle dispersion and a releasing agent particle dispersion.

3. The method for producing a toner for developing an electrostatic charge image according to claim 2, wherein, in the aggregating, the dispersion is obtained by mixing at least a coloring particle dispersion in addition to the resin particle dispersion and the releasing agent particle dispersion.

4. The method for producing a toner for developing an electrostatic charge image according to claim 3, wherein at least one dispersion selected from the resin particle dispersion, the releasing agent particle dispersion, and the coloring particle dispersion has a zeta potential of −50 mV or less.

5. The method for producing a toner for developing an electrostatic charge image according to claim 3, wherein a difference between a maximum value and a minimum value among a zeta potential of the resin particle dispersion, a zeta potential of the releasing agent particle dispersion, and a zeta potential of the coloring particle dispersion is 50 mV or less.

6. The method for producing a toner for developing an electrostatic charge image according to claim 4, wherein a difference between a maximum value and a minimum value among a zeta potential of the resin particle dispersion, a zeta potential of the releasing agent particle dispersion, and a zeta potential of the coloring particle dispersion is 50 mV or less.

7. The method for producing a toner for developing an electrostatic charge image according to claim 1, wherein the resin particles contain polyester resin particles.

8. The method for producing a toner for developing an electrostatic charge image according to claim 2, wherein the resin particles contain polyester resin particles.

9. The method for producing a toner for developing an electrostatic charge image according to claim 3, wherein the resin particles contain polyester resin particles.

10. The method for producing a toner for developing an electrostatic charge image according to claim 4, wherein the resin particles contain polyester resin particles.

11. The method for producing a toner for developing an electrostatic static charge image according to claim 5, wherein the resin particles contain polyester resin particles.

12. The method for producing a toner for developing an electrostatic charge image according to claim 6, wherein the resin particles contain polyester resin particles.

13. The method for producing a toner for developing an electrostatic charge image according to claim 1, wherein a trivalent or higher metal ion salt compound is contained as the aggregating agent.

14. The method for producing a toner for developing an electrostatic charge image according to claim 2, wherein a trivalent or higher metal ion salt compound is contained as the aggregating agent.

15. The method for producing a toner for developing an electrostatic charge image according to claim 3, wherein a trivalent or higher metal ion salt compound is contained as the aggregating agent.

16. The method for producing a toner for developing an electrostatic charge image according to claim 4, wherein a trivalent or higher metal ion salt compound is contained as the aggregating agent.

17. The method for producing a toner for developing an electrostatic charge image according to claim 13, wherein a trivalent aluminum salt compound is contained as the aggregating agent.

18. The method for producing a toner for developing an electrostatic charge image according to claim 1, wherein a total amount of the aggregating agent added relative to a total mass of toner particles to be obtained is 0.1 mass % or more and 2.0 mass % or less.

19. The method for producing a toner for developing an electrostatic charge image according to claim 1, wherein the dispersion is returned to the stirring vessel at a position on a lower side in a direction of gravitational force with respect to a liquid level of the dispersion in the stirring vessel.

20. A toner for developing an electrostatic charge image, the toner being obtained by the method for producing a toner for developing an electrostatic charge image according to claim 1.
